(19) United States
(12) Patent Application Publication
(10) Pub. No.: US 2019/0010066 A1
(43) Pub. Date: Jan. 10, 2019

(54) DECENTRALIZED WASTEWATER TREATMENT SYSTEM FOR REMOVING PHOSPHOROUS

(71) Applicant: ZOELLER PUMP COMPANY, LLC, LOUISVILLE, KY (US)

(72) Inventors: MATTHEW BYERS, Lawrenceburg, KY (US); NEWT KUO, Louisville, KY (US); DANIEL MASTERSON, Louisville, KY (US); ANDREW WESTPHAL, Bedford, KY (US)

(21) Appl. No.: 16/026,218

(22) Filed: Jul. 3, 2018

Related U.S. Application Data
(60) Provisional application No. 62/529,159, filed on Jul. 6, 2017.

(51) Int. Cl. C02F 1/68; C02F 1/00; C02F 3/30

(52) U.S. Cl. CPC C02F 1/683; C02F 1/008; C02F 3/308; C02F 2101/105; C02F 2301/024; C02F 2209/18; C02F 2301/046

(57) ABSTRACT

An on-site decentralized wastewater treatment system for treating phosphorous-containing wastewater including a sedimentation chamber and an anaerobic treatment system and/or an aerobic treatment system, along with a recirculation system which recirculates treated wastewater within the treatment system. The system further includes a system for introduction of a chemical agent into the recirculation system for complexing the phosphorous-containing compounds present in the wastewater.

### CROSS REFERENCE TO RELATED APPLICATION

This Application claims priority from provisional application Ser. No. 62/529,159, filed Jul. 6, 2017.

### BACKGROUND OF INVENTION

Wastewater treatment is a process of removing impurities from wastewater. An objective of wastewater treatment is to produce a stream of treated wastewater suitable for discharge back in the environment. Wastewater treatment may comprise primary treatment, secondary treatment, and/or tertiary treatment. Primary treatment can involve use of septic tanks to separate solids, fats, oils, greases and produce a primary treated wastewater. Secondary treatment may be used to substantially degrade the impurities contained in the wastewater after primary treatment and may include the functions of biochemical oxygen demand (“BOD”) and total suspended solids (“TSS”) removal and reduction, among others. Tertiary treatment is often utilized for the removal of phosphorous and nitrogen-containing impurities.

Municipal wastewater treatment systems use numerous types of treatment systems to treat wastewater. It is a requirement of modern municipal wastewater treatment systems to adequately treat wastewater prior to discharging said treated wastewater. Municipal waste treatment systems generally use a centralized collection system along with primary, secondary and tertiary treatment systems which include physical, biological and chemical processing. These multi-million dollar wastewater treatment systems use a number of different types of wastewater treatment prior to discharge of the treated water from the wastewater system. As an example, see “Primer for Municipal Wastewater Treatment Systems” EPA 832-R-04-001 (September 2004).

All households do not have access to such municipal wastewater treatment systems and, therefore, often utilize decentralized, on-site systems for the treatment of wastewater. In the past, many of these systems merely utilized primary treatment systems, such as septic tanks, and then discharged partially treated wastewater into the environment.

Jokaso-type wastewater treatment systems represent a form of wastewater treatment which was introduced during the last thirty (30) years, is designed for use for decentralized wastewater treatment and is a superior wastewater treatment system to the use of septic tanks alone. Typical Jokaso devices include as many as five functional chambers. In one example, a first chamber works as a trash tank under anaerobic conditions, much like a septic tank. A second chamber is typically filled with filter media for anaerobic biofilm filtration process. A third chamber is also filled with filter media but is kept aerobic by introduction of compressed air. A fourth chamber may be utilized as a buffer storage tank for the treated water. A fifth chamber may be used for disinfection purposes, sometimes referred to as a tertiary treatment system.

One specific type of Jokaso wastewater treatment systems for small scale residential and commercial wastewater treatment is the Fusion® Series Treatment Systems by Zoeller Pump Company, LLC. The Fusion® System, as shown in Fusion® Series Treatment Systems Owner's Manual for small commercial models ZFL1120-ZFL2400, is a treatment system utilizing a sedimentation chamber, an anaerobic filtration chamber, an aerobic contact filtration chamber, and a storage container for the storage of treated wastewater, which can either be discharged or recycled for further treatment within the system.

Some wastewater treatment systems also utilize UV treatment devices to reduce production of organic materials formed within the wastewater treatment system. An example of such a device is shown in U.S. Pat. No. 8,795,600.

A common contaminant in wastewater, which is generally treated by municipal centralized treatment systems, is phosphorous compounds. In these municipal wastewater treatment systems, phosphorous compound removal can be accomplished by various techniques including filtration, chemical complexation, adsorption and biological treatment. Large wastewater treatment facilities often treat phosphorous in a tertiary treatment system. In one form of treatment, these systems subject phosphorous compounds to electro-chemical treatment to precipitate complexed phosphorous compounds from the wastewater, often using ferric ions. After such treatment, the treated wastewater can be discharged through an adsorption bed where the complexed phosphorous compounds are trapped.

There have been various additional systems that have been designed for the removal of phosphorous compounds from wastewater that can be utilized in combination with decentralized systems, such as the Jokaso-type systems. For example, in a tertiary treatment stage, phosphorous compounds may be removed via iron electrolysis, as utilized in the Fuji Clean treatment technology that is discussed in Otowa, et al.: PERSPECTIVES OF UPDATED JOKASO (ONSITE WASTEWATER TREATMENT UNIT) SYSTEM IN AUSTRALIA (2014). Other systems have used natural materials, such as zeolites or sand filters, to remove the phosphorous compounds. Also utilized are iron-containing materials, such as furnace slag. Another methodology for the removal of phosphorous is a post-secondary treatment system using precipitation, wherein Zn, Fe and Al compounds are added to the treated wastewater.

One embodiment of the present invention is a decentralized, on-site wastewater treatment system which includes an unique device and method for complexation and removal of phosphorous compounds from wastewater during a recirculation cycle within the wastewater treatment system.

### BRIEF DESCRIPTION OF THE DRAWINGS

FIG. 1 is a decentralized, on-site wastewater treatment system for introduction of chemical agents using a tablet feeder into a recirculation system for removal of phosphorous compounds from the wastewater.

FIG. 2 is an alternative embodiment of the decentralized, on-site wastewater treatment system of FIG. 1 utilizing a secondary treatment system wherein chemical agents are introduced into a recirculation system using a tablet feeder for removal of phosphorous compounds from the wastewater.

FIG. 3 is an alternative embodiment of the decentralized, on-site wastewater treatment system of FIG. 1 showing the tablet feeder located near a discharge portion of the recirculation system.

FIG. 4a is a cut away, side view of the tablet feeder system within the recirculation system as shown in FIG. 1.

FIG. 4b is a top view of the tablet feeder system, as shown in FIG. 1, used with a static mixer with baffles and recirculation system phosphorous sensor all located within the recirculation system.

FIG. 5 is a decentralized on-site wastewater treatment system for introduction of chemical agents using a liquid feeder into the recirculation system for removal of phosphorous compounds from the wastewater.

FIG. 6 is an alternative embodiment of FIG. 5 showing the liquid feeder near the discharge portion of the recirculation system.

FIG. 7a is a cut away, side view of the liquid feeder system of FIG. 6 showing introduction of a liquid chemical agent into the recirculation system.

FIG. 7b is a top view of a portion of the recirculation system of FIG. 6 showing a recirculation system liquid feeder opening, static mixer with baffles, and phosphorous sensor all located within the recirculation system.

FIG. 8 is an alternative embodiment of FIG. 2 showing use of the liquid feeder system of FIG. 5 within the decentralized on-site wastewater treatment.

### DETAILED DESCRIPTION OF ONE EMBODIMENT OF THE INVENTION

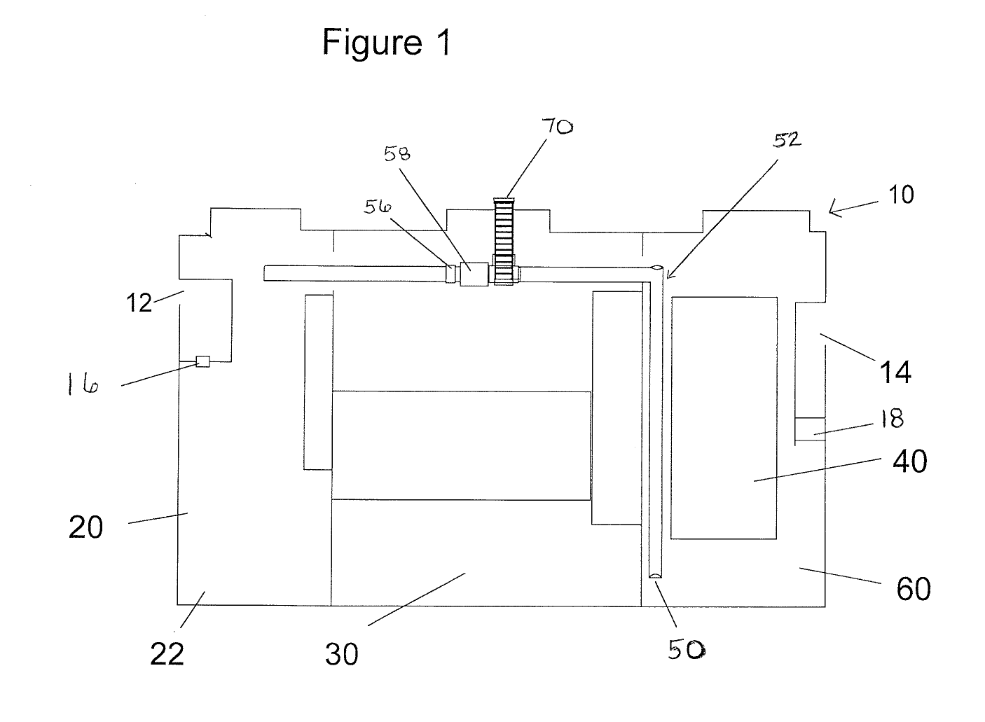

One embodiment of an on-site or decentralized wastewater treatment system (10), which removes phosphorous compounds from wastewater during a recirculation cycle, is disclosed in FIG. 1.

In this embodiment wastewater enters the inlet (12) of the system (10) and flows into a sedimentation chamber (20). This sedimentation chamber is designed to physically separate solids (sludge) (22) and floating materials (scum) from the incoming wastewater. The sludge falls to the bottom of the chamber for later removal. The scum remains in the chamber and is either decomposed or removed. Access to the sedimentation chamber is important for removal of this sludge and scum and is accomplished through convention openings in the top of the chamber.

To monitor the level of the sludge that is present in the sedimentation chamber, preferably a sensor (not shown) is installed in the chamber to alert the user thereof that there has been too much build up of sludge within that sedimentation chamber. This sensor reads the level of sludge that is present in the sedimentation chamber using, for example, an ultrasonic transducer using a sonar technique, pressure sensors and/or infrared LEDs. This sensor is placed in the sedimentation chamber (20) so that it is located where the majority of the sludge settles within the system (10). Further, this sensor preferably has an alarm system (not shown) attached thereto which alerts the user when the level of the sludge is excessive.

Following primary treatment for removal of sludge and scum from the wastewater, in one embodiment, the treated wastewater enters an anaerobic treatment chamber (30) which may include filter media, as shown in FIG. 1. One example of such filter media is spherical-skeleton-type filter media. Fixed film processes on the surface of the filter media encourage biological anaerobic reaction which results in suspended solids being captured. Further, anaerobic microorganisms grow in the chamber and convert nitrates in the wastewater to nitrogen, which escapes to the environment. Anaerobic processes in media are effective because of the 3-dimensional aspect of the sludge blanket through which the fluid flows. Reduction of waste strength, denitrification, TSS arresting are among the benefits.

Following anaerobic treatment in the anaerobic treatment chamber (30), the treated wastewater flows into an aerobic treatment chamber (40), as shown in FIG. 1. This chamber is filled with filter media upon which aerobic microorganisms grow for biological treatment of aerobic materials present in the wastewater. In one embodiment, the aerobic filter media chamber contains an aeration upper section and a filter media lower section. This filter media lower section is filled with filter media, such as hollow cylindrical filter media. Biological treatment takes place with the help of fixed film growth on the surface of the filter media. Aeration is continuous to promote growth of aerobic microorganisms. Residual suspended solids slough off the media into the bottom of the aerobic chamber and are returned to the sedimentation chamber (20) by recirculation system (50). To improve the aeration process, the filter media in this chamber is backwashed regularly by a backwash system located at the bottom of the chamber.

The decentralized wastewater treatment system (10) may contain one or both of an anaerobic treatment chamber and an aerobic treatment chamber. In addition, the order of flow of the wastewater through these respective chambers may be modified at the desire of the user.

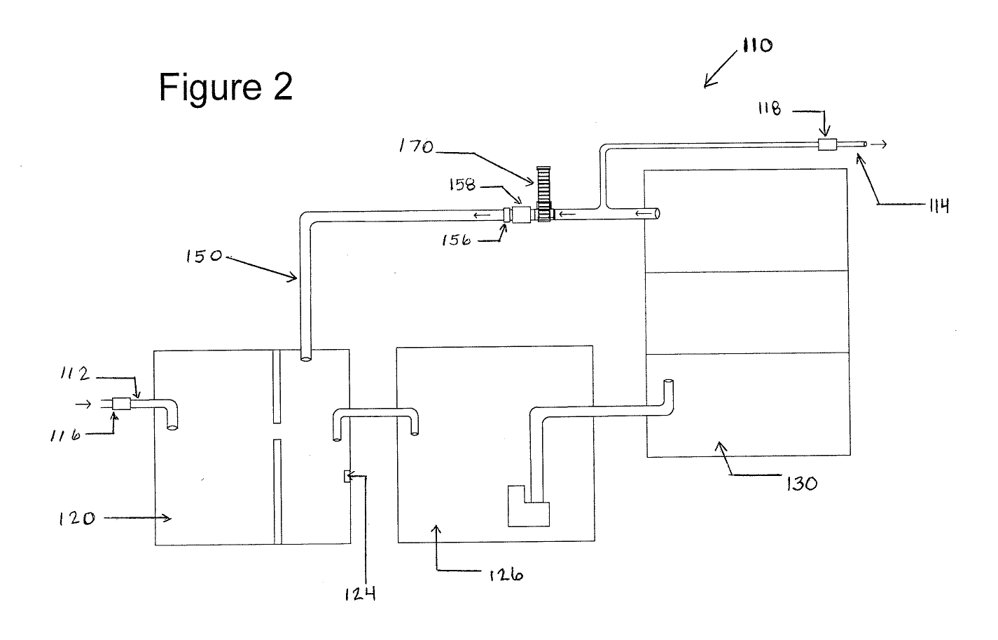

In another embodiment, as shown in FIG. 2, the secondary wastewater treatment system (110) includes either an anaerobic or aerobic treatment system, utilizing, for example, a gravel filter (130) into which the wastewater is pumped after initial treatment. Depending on the arrangement of the material within this gravel filter, the secondary treatment can be either aerobic or anaerobic or both.

In a preferred embodiment, a portion or all of the treated wastewater is recirculated using a recirculation system (50), as shown in FIG. 1. In one embodiment, the recirculation system utilizes an airlift pump with recirculation piping (52) for passage of the wastewater back into the sedimentation chamber (20) for further treatment. The recirculation process can be repeated multiple times.

It has been discovered that treatment of wastewater in the recirculation system (50) with chemical agents useful for complexing phosphorous compounds present in the wastewater is surprisingly effective to remove phosphorous compounds from wastewater that enter the wastewater treatment system (10). Examples of such chemical agents include metal salt reagents, such as pre-hydrolyzed metal salt reagents, which may include various metals, metal salts, metal compounds or combinations thereof, with the metals selected from iron, aluminum, manganese, zinc, copper, magnesium and calcium with iron, zinc and aluminum preferred. Although the chemical agents can be introduced in various forms, preferred embodiments utilize introduction in either a solid, tablet form or a dissolved liquid form.

The introduction of these chemical agents into the recirculation system can be by use of various systems, such as a tablet feeder, a solid mass feeder, a liquid chemical feeder, a venturi feeder and other types of introduction devices for introduction of solid or liquid compounds into the recirculating wastewater while present in the recirculation system. Control of the quantity and state of these agents that are introduced into the recirculation system is by use of these systems.

In one embodiment as shown in FIGS. 1, 2, 3, and 4a, solid chemical tablets (72) are used for introduction of the chemical agents into the recirculation system (50). The system for introduction of solid chemical tablets can be regulated so that the quantity of the metal salt compounds to be introduced can be increased or decreased depending on the level of phosphorus in the wastewater.

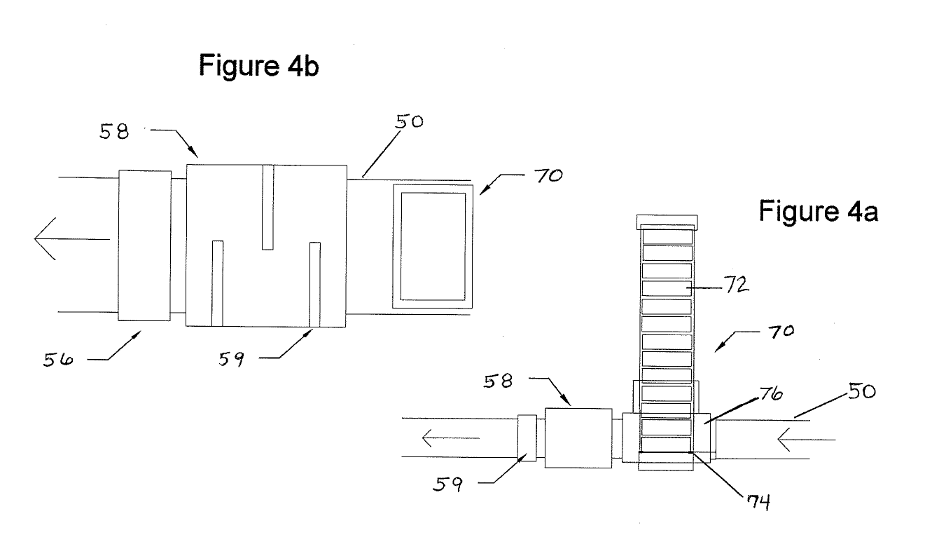

In one embodiment, as shown in FIGS. 1, 3 and 4a, the device for the introduction of a solid chemical agent is a tablet feeder (70). In this embodiment, tablets (72) containing the chemical agent are stored within the tablet feeder, with the bottom tablet resting on tablet ledges (74) of the tablet feeder (70). As shown in FIG. 4a, wastewater enters a tablet feed chamber (76) and flows around a tablet to slowly dissolve the tablet. The chemical agent present in the tablet is released into the wastewater present in the recirculation system.

To assist in the mixing of the chemical agent throughout the wastewater present in the recirculation system, it has been surprisingly discovered that it is useful to utilize some form of mixing device, such as a static mixer (58) with baffles (59), to create a turbulent flow of the wastewater in the recirculation system, as shown in FIGS. 4a and 4b. Essentially, this baffled static mixer (58) increases the interface between the chemical agent and the wastewater in the recirculation system, thereby increasing the effectiveness of the chemical agent in complexing phosphorous compounds.

It is also preferable that there be a recirculation system phosphorous sensor (56) located in the recirculation system after the static mixer (58) to sense the level of the chemical agent that is present in the recirculation system, as shown in FIG. 4b. When the level of that chemical agent drops, this is an indication that additional chemical agent tablets should be added through the tablet feeder (70).

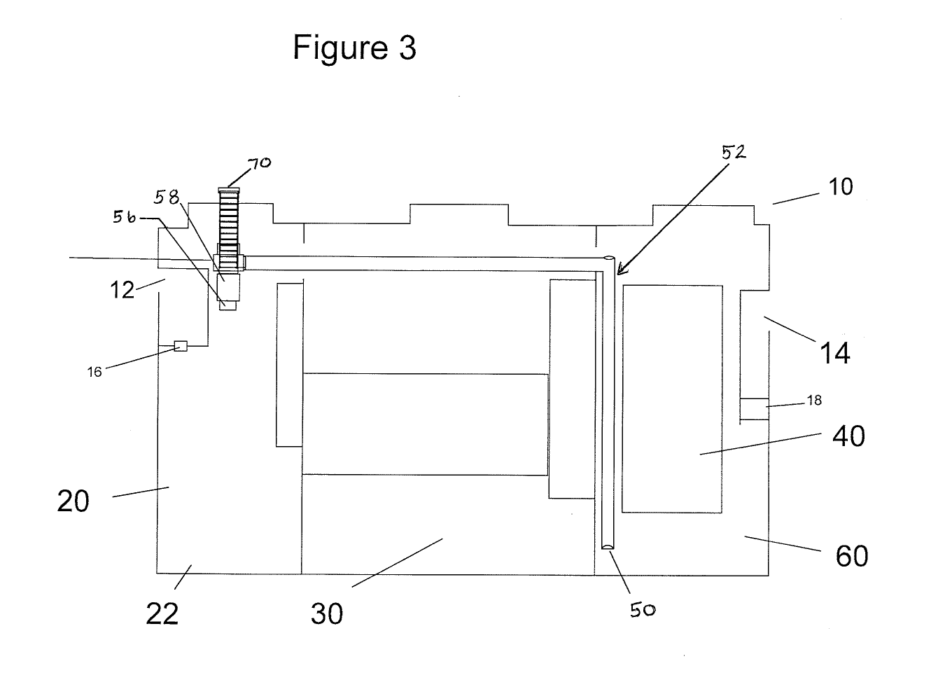

While, in one embodiment, FIG. 1 shows the presence of the tablet feeder (70), static mixer (58) and recirculation system phosphorous sensor (56) located toward the middle of the recirculation system, it is also possible for these components to be located at any place within the recirculation system, including near the discharge from the recirculation system, as shown in FIG. 3. The location within the recirculation system is not particularly critical and is usually associated with ease of access to the tablet feeder (70) within the wastewater treatment system (10).

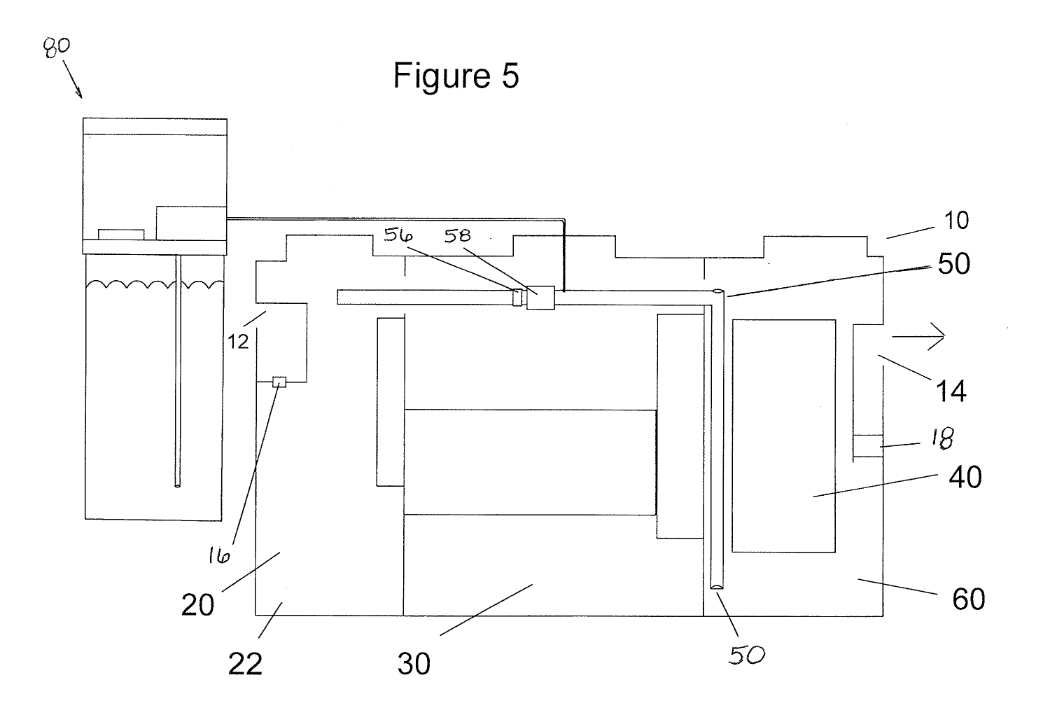

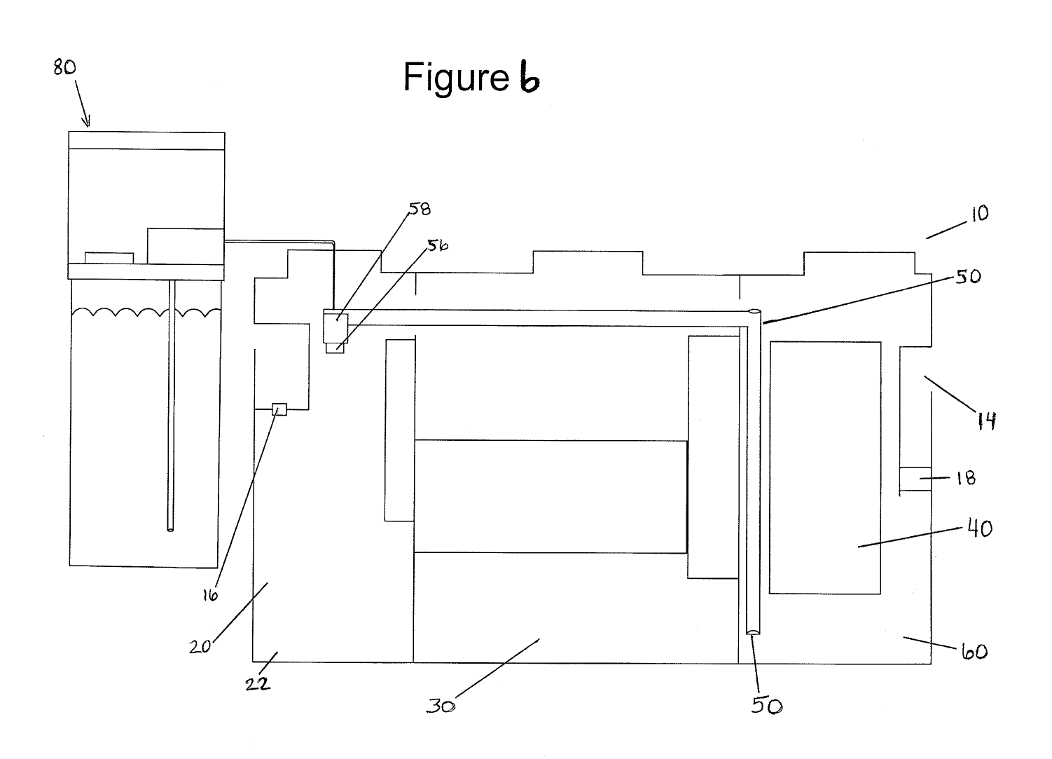

In an alternative embodiment as shown in FIGS. 5, 6 and 8, instead of the use of a solid tablet feeder (70) for introduction of the chemical agent into the recirculation system, an alternative embodiment is the use a liquid feeder (80) to introduce the chemical agent into the recirculation system. FIG. 5 shows a recirculation system liquid feeder opening (54) near the middle of the recirculation system, while FIG. 6 shows the recirculation system liquid feeder opening (54) near the discharge from the recirculation system.

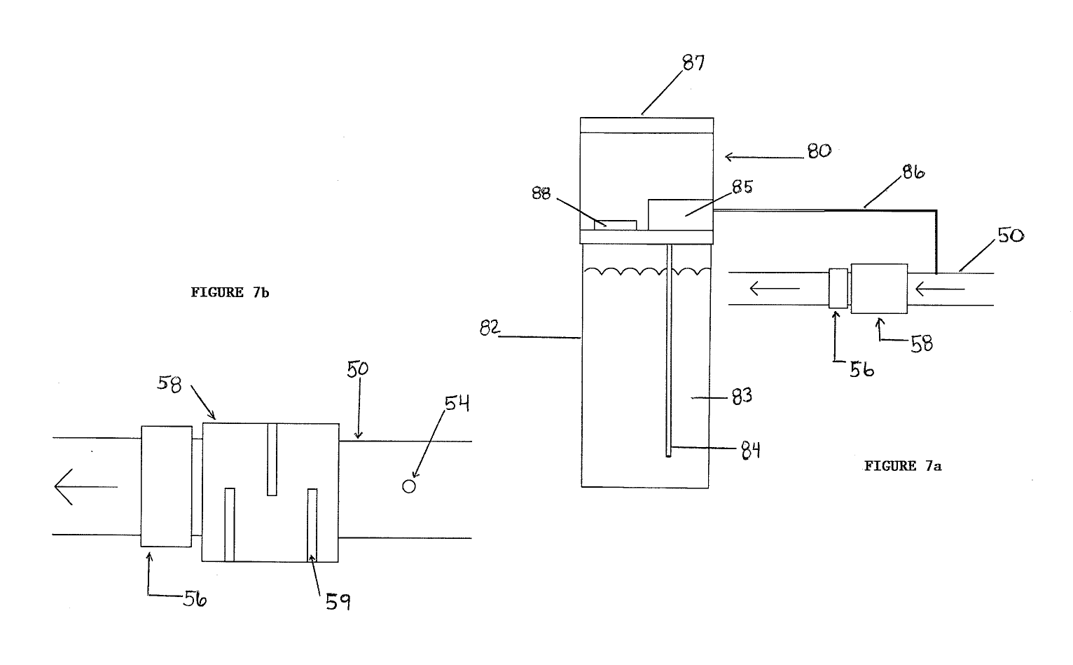

The particular components of the liquid feeder depend upon the chemical agent being added and the desire of the user of the system. In one embodiment, as shown in FIG. 7a, the liquid feeder (80) includes a storage container (82), which stores the liquid chemical agent (83). A suction hose (84) draws out the liquid chemical agent (83) from the storage container (82) for introduction into the recirculation system through the recirculation system feeder opening (54). Conventional devices can be used for this suction procedure, such as a peristaltic pump, battery and timer (85), which passes the liquid chemical agent (83) through the discharge line (86) for introduction into the recirculation system. Conventional power systems can be utilized to operate the system for the introduction of the liquid chemical agent. In one embodiment, a solar panel (87) is used to produce the electricity necessary for its operation. Further, the storage container (82) includes a refill access (88) to introduce additional liquid chemical agent, as needed. A sensor (not shown) can also be present within the storage container (82) to sense the level of liquid chemical agent present in the storage container.

The liquid chemical agent is introduced through the recirculation system liquid feeder opening (54), as shown in FIGS. 5 and 7a. As with the tablet feeder system, a static mixer (58) with baffles (59) can be used to blend the liquid chemical agent with the wastewater that is present within the recirculation system, as shown in FIG. 7b. Also, a recirculation system phosphorous sensor (56), as shown in FIGS. 5, 6 and 7b, can be present to sense the level of phosphorous in the recirculation system, which assists in informing the user when the level of liquid chemical agent has dropped. As with the use of the tablet feeder, the recirculation system opening (54), static mixer (58) and recirculation system phosphorous sensor (56) can be located any place on the recirculation system, such as in the middle of the recirculation system, as shown in FIG. 5 or at the discharge from the recirculation system, as shown in FIG. 6.

The recirculation piping (52) feeds the treated wastewater back into the sedimentation chamber at which location the complexed phosphorous compounds fall out of the wastewater to be incorporated into the sludge that is present at the bottom of the sedimentation chamber. The sludge, including the complexed phosphorous material, is removed on a regular basis from the sedimentation chamber. By use of this phosphorous complexing chemical agent introduced into the recirculation system, phosphorous materials are removed efficiently from the wastewater without the need for a separate phosphorous removal system.

After the previously treated wastewater has been recirculated into the sedimentation chamber, it mixes with wastewater present in that chamber for further treatment through the sedimentation chamber, anaerobic chamber and the aerobic filter media chamber, as desired. After treatment in the various portions of the treatment system, the treated wastewater can be stored in a treated water storage chamber (60), which is present in the wastewater treatment system, prior to discharge.

Ultimately, treated wastewater is discharged from the system, after there has been sufficient treatment of the wastewater, through the outlet (14) of the system. The ultimate amount of treated wastewater that is discharged during each cycle can be controlled by adjustments to the system, as are known in the industry.

To monitor the level of phosphorous compounds that enter the wastewater treatment system, an inlet phosphorous sensor (16) is preferably present near inlet (12). To determine the overall effectiveness of removal of phosphorous compounds from the system, it is preferable to also utilize an outlet phosphorous sensor (18) near the outlet (14). By comparing the level of phosphorous compounds shown by these sensors, the overall effectiveness of the system to remove phosphorous compounds can be evaluated and adjusted.

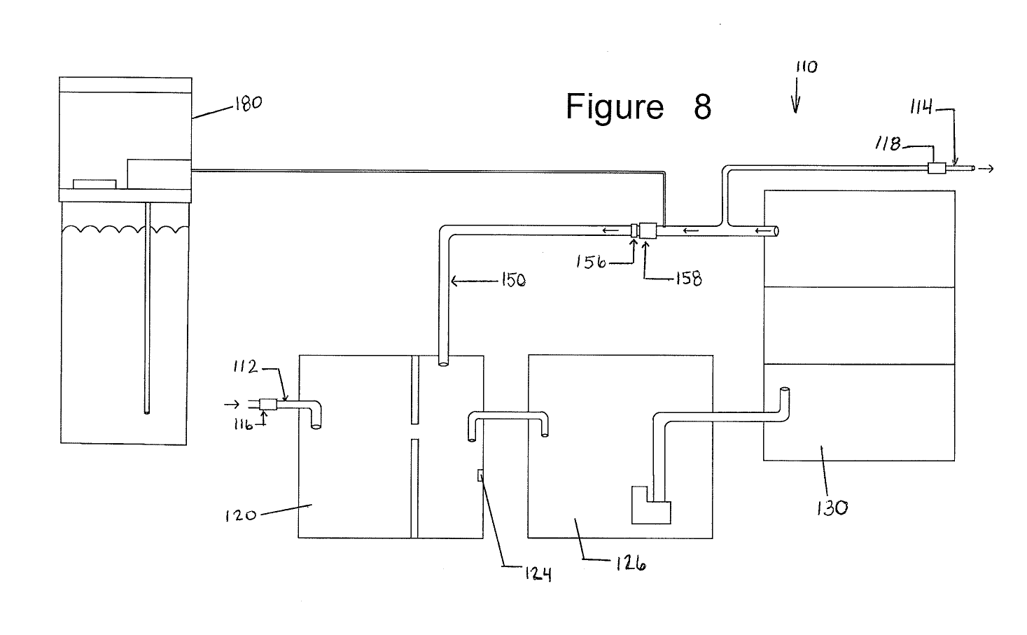

In an alternative embodiment, as shown in FIGS. 2 and 8, the secondary wastewater treatment system (110) includes an inlet (112) to a sedimentation chamber (120), which acts as a septic tank. This sedimentation chamber contains a sludge sensor (124), so that the user can monitor the level of sludge within the sedimentation chamber. Wastewater from this sedimentation chamber then flows to a separate pump chamber (126), and is pumped to a secondary treatment system, such as a gravel filter (130). This gravel filter is arranged as either an aerobic or anaerobic system or both, as desired. After treatment through this secondary treatment system, some portion or all of the treated wastewater passes through a recirculation system (150), where it is accessed by either a solid or liquid feeder system, as discussed above. For example, in one embodiment, as shown in FIG. 2, a tablet feeder (170), with static mixer (158) and phosphorous sensor (156), is incorporated into the recirculation system with the wastewater after treatment with the chemical agents provided from the tablets of the tablet feeder (170). The treated wastewater then flows back into the sedimentation chamber for further treatment. After further treatment through the secondary treatment system, some portion of this treated wastewater can be discharged through an outlet (114) with the remaining portion passed again through the recirculation system. Phosphorous sensors (116, 118) may be present near the inlet (112) and the outlet (114) respectively to compare the level of phosphorous entering the system (110) with the level after treatment. Depending on the difference in level of phosphorous, the amount of the chemical agent dispensed can be modified.

In an alternative embodiment as shown in FIG. 8, a liquid feeder system (180), as discussed above, is utilized as the system for treating the effluent that passes through the recirculation system. After leaving the system, the treated wastewater may be discharged into the environment or transferred for further treatment, as desired by the consumer. In one preferred embodiment the treated wastewater passes into a soil adsorption field for final disposal of the treated wastewater.

Alternatively, some systems also include use of a conventional septic tanks prior to the wastewater treatment system.

Further, a secondary wastewater treatment system may be utilized in sequence to further treat the wastewater before final discharge into the environment. Among the secondary wastewater treatment systems that are utilized with the onsite decentralized wastewater treatment system include a packed bed filter, a recirculating sand filter, a gravel filter with a gravel filter preferred, an aerobic treatment system or an anaerobic treatment system.

Other methodologies and other arrangements of sedimentation chambers and secondary and tertiary treatment systems can be utilized for the treatment of wastewater.

It is well recognized by persons skilled in the art that alternative embodiments to those disclosed herein, which are foreseeable alternatives, are also covered by this disclosure. The foregoing disclosure is not intended to be construed to limit the embodiments or otherwise to exclude such other embodiments, adaptations, variations, modifications and equivalent arrangements.

### LIST OF COMPONENTS

10—wastewater treatment system
12—inlet
14—outlet
16—inlet phosphorous sensor
18—outlet phosphorous sensor
20—sedimentation chamber
22—sludge
30—anaerobic treatment chamber
40—aerobic treatment chamber
50—recirculation system
52—recirculation piping
54—recirculation system liquid feeder opening
56—recirculation system phosphorous sensor
58—static mixer
59—baffles
60—treated water storage chamber
70—tablet feeder
72—tablets
74—tablet ledges
76—tablet feeder chambers
80—liquid feeder
82—storage container
83—liquid chemical agent
84—suction hose
85—peristaltic pump, battery and timer
86—discharge line
87—solar panel
88—refill access
110—secondary wastewater treatment system
112—inlet
114—outlet
116—phosphorous sensor
118—phosphorous sensor
120—separate sedimentation chamber
124—sludge sensor
126—separate pump chamber
130—gravel filter
150—recirculation system
156—recirculation system phosphorous sensor
158—static mixer
170—tablet feeder
180—liquid feeder

1. An on-site, decentralized wastewater treatment system for treating phosphorous-containing wastewater comprising
an inlet for receiving the wastewater,
a sedimentation chamber for receiving wastewater from the inlet,
an anaerobic treatment system and/or an aerobic treatment system for receiving and treating wastewater,
a recirculation system which recirculates treated wastewater back to the sedimentation chamber,
a system for introduction of chemical agents into the recirculation system for treating phosphorous-containing compounds present in the wastewater, and
an outlet to discharge treated wastewater from the wastewater treatment system.

2. The wastewater treatment system of claim 1 wherein the system for introduction of chemical agents into the recirculation system is selected from the group consisting of a venturi apparatus, a liquid pump, syphon or gravity dripped structure, and a structure for holding solid tablets or other solids containing metals or metal salts.

3. The recirculation system of claim 1 wherein the chemical agents used for complexing of the phosphorous-containing compound is selected from the group consisting of ammonium compounds, ferric compounds, aluminum compounds and calcium compounds.

4. The wastewater treatment system of claim 1 wherein the chemical agents are contained in dissolvable tablets containing a compound comprising a metal or metal salt with the metal selected from the group consisting of aluminum, iron and calcium.

5. The wastewater treatment system of claim 1 wherein the system for introduction of chemical agents into the recirculation system comprises a tablet feeder for holding solid chemical agent tablets.

6. The wastewater treatment system of claim 5 further comprising a static mixer in the recirculation system comprising a turbulent zone for blending of the chemical agents from the tablets with the wastewater.

7. The wastewater treatment system of claim 6 further comprising baffles present in the static mixer.

8. The wastewater treatment system of claim 5 wherein the recirculation system further comprises a sensor for sensing the level of phosphorous-containing compounds present in the wastewater within the recirculation system.

9. The wastewater treatment system of claim 1 further comprising a sensor for sensing the level of phosphorous containing compounds in the wastewater prior to discharge through the outlet.

10. The wastewater treatment system of claim 1 wherein the system for introduction of chemical agents into the recirculation system comprises a liquid feeder containing the chemical agents dissolved within a liquid, wherein the liquid feeder conveys said chemical agents dissolved within the liquid from a storage container into the recirculation system.

11. The wastewater treatment system of claim 10 further comprising a static mixer comprising a turbulent zone for blending chemical agents dissolved within the liquid from the liquid feeder with wastewater from the recirculation system.

12. The wastewater treatment system of claim 11 further comprising baffles present in the static mixer.

13. The wastewater treatment system of claim 10 wherein the recirculation system further comprises a sensor for sensing the level of phosphorous-containing compounds present in the wastewater in the recirculation system.

14. A process for the treatment of phosphorous-containing wastewater in an on-site wastewater treatment system comprising
introducing wastewater into an inlet of the wastewater treatment system,
passing the wastewater from the inlet into a sedimentation chamber for removal of sludge and scum from the wastewater,
introducing wastewater from the sedimentation chamber into an anaerobic and/or an aerobic wastewater treatment chamber, and
recirculating wastewater through a recirculation system back to the sedimentation chamber,
wherein a chemical agent for complexing phosphorous-containing compounds present in the wastewater is introduced into the wastewater in the recirculation system prior to reintroduction of the wastewater into the sedimentation chamber, and
discharging treated wastewater through an outlet of the wastewater treatment system.

15. The process of claim 14 wherein the chemical agent is introduced into the wastewater present in the recirculation system by passing said wastewater through a tablet feeder holding solid tablets containing chemical agents for the treatment of phosphorous-containing compounds present in the wastewater.

16. The process of claim 14 wherein the chemical agent is introduced into the wastewater present in the recirculation system by introduction of the chemical agents in liquid form from a liquid feeder.

17. The process of claim 15 further comprising passing the wastewater in the recirculation system after introduction of the chemical agent through a static mixer containing baffles which create a turbulent flow of the wastewater in the recirculation system.

18. The process of claim 15 further comprising sensing the level of the phosphorous-containing compounds present in the recirculation system by use of a sensor.

19. The process of claim 16 further comprising passing the wastewater in the recirculation system after introduction of the chemical agent through a static mixer containing baffles which create a turbulent flow of the wastewater in the recirculation system.

20. The process of claim 16 further comprising sensing the level of the phosphorous-containing compounds present in the recirculation system by use of a sensor.
